(19) United States
(12) Patent Application Publication
(10) Pub. No.: US 2025/0002176 A1
(43) Pub. Date: Jan. 2, 2025

(54) FLIGHT TEST RANGE SAFETY ANALYSIS TOOL

(71) Applicant: RAFAEL ADVANCED DEFENSE SYSTEMS LTD., Haifa (IL)

(72) Inventors: Ronen INGBIR, Ramat Gan (IL); Nave BEN -YAKOV, Yaad (IL)

(21) Appl. No.: 18/709,777

(22) PCT Filed: Jan. 16, 2023
(86) PCT No.: PCT/IL2023/050047

§ 371 Date: May 13, 2024

(30) Foreign Application Priority Data
Jan. 24, 2022 (IL) 290207

(51) Int. Cl. B64F 5/60; G06F 30/20; G06F 119/14

(52) U.S. Cl. CPC B64F 5/60; G06F 30/20; G06F 2119/14

(57) ABSTRACT

A method of assessing safety of a trajectory of units under test over a flight range includes: setting a mission trajectory of a unit under test, wherein nominal and dispersion trajectories of the unit under test are within a delineated area; extracting from the mission trajectory a plurality of initial conditions of the unit under test; for each extracted initial condition, simulating a malfunction, and calculating an orientation of the unit under test following each simulated malfunction using an orientation transfer function of the unit under test to simulate a malfunction maneuver. The method further includes, on the basis of this calculated orientation for each simulated malfunction, determining an impact point of the unit under test with a particular plane.

### RELATED APPLICATIONS

This application claims the benefit of priority to Israeli Patent Application No. 290,207, filed Jan. 24, 2022, entitled “Flight Test Range Safety Analysis Tool,” the contents of which are incorporated by reference as if fully set forth herein.

### FIELD OF THE INVENTION

The present disclosure, in some embodiments, concerns a tool for analyzing flight test range safety, and more specifically, but not exclusively, to a simplified approach for simulating a malfunction maneuver, by using the orientation in three axes and its derivatives as the basis for a transfer function of any order, including a second order transfer function with time derivatives. These malfunction trajectories are the basis of flight test mission planning under test range and regulatory constraints including the requirement of a comprehensive risk assessment.

### BACKGROUND OF THE INVENTION

A flight test range is a defined geographic area where research and development of flying UUTs (units under test), for example missiles and drones, are conducted. For safety, it is necessary to ensure that all units under test (e.g., missiles and their components/debris etc.) shot during the flight test land within a delineated area. This applies to nominal dispersions and all malfunctions. In addition, it is desirable that this delineated area be as small as feasible.

In case of malfunction, there is significant risk that a body under test would exit the delineated area. In order to prevent such exiting of the delineated area, a flight termination system (FTS) and/or autonomous flight termination system (AFTS) may be included in the body under test, and may be implemented by an operator of the test range as needed (or automatically, in the case of an AFTS). When the FTS is activated, the body breaks apart or loses its capacity to maneuver, and starts a free fall to the ground. For example, following implementation of the flight termination system, the body continues on its prior trajectory as it falls to the ground, with only drag applying an additional force on the body.

When designing a flight test mission, it is necessary to evaluate potential ground impact points of falling parts, in order to verify that, even in event of a malfunction, any falling parts would remain within a delineated area in the flight test range. This is the case whether a flight termination system is available or not. If a flight termination system is not available (for example, no FTS is installed, or the FTS malfunctions) the maneuvers of the unit under test following malfunction may exceed the boundaries of the delineated area. In these cases, a risk assessment is performed based on the malfunction simulations, calculating the risk of landing outside the delineated area, and making sure that this risk is acceptable according to regulatory requirements.

### SUMMARY OF THE INVENTION

The present disclosure devises a simplified, streamlined approach for modeling potential impact points of units under test, based on the position, velocity and orientation of the units under test prior to a simulated malfunction. In a typical example, the impact point of interest is a ground impact point, although other impact planes may also be relevant.

One approach for evaluating potential ground impact points is to simulate effects caused by specific types of malfunctions. However, this approach is unnecessarily intensive, because there are many types of malfunctions, and it is almost impossible to simulate them all. In addition, the different types of malfunctions have no direct correlation with ground impact points, and are relevant only insofar as they affect the trajectory of the unit under test.

A second approach is to calculate the ground impact points on the basis of the projected maneuvering of the unit following the malfunction. This approach is appropriately based on the reality that, for purposes of calculating the ground impact point, the actual cause of the malfunction is irrelevant. All that is relevant is that the malfunction causes the unit to maneuver in some direction. For example, if one of the actuators fails and is stuck in a certain position, the unit will in turn maneuver in a certain direction.

More specifically, the maneuvering of a unit in air depends on the unit's current physical states—position, velocity, acceleration, and orientation. Using those current physical states and properties of the unit, including aerodynamic properties, mass, and thrust, it is possible to calculate current forces acting on the unit. Integrating these forces, applying Newton's second law of motion, allows for calculation of a sequence of physical states of the unit, until the unit reaches the ground. These principles may likewise be applied in order to calculate the maneuvering of the unit following the malfunction.

In practice, however, direct implementation of this approach is also highly computationally intensive. In particular, in order to calculate the ground impact point using this technique, it is necessary to determine accurately the unit's orientation, in up to three axes. As is well known, position is the integral of velocity over time, and velocity is the integral of acceleration over time. An acceleration of a body at any given point in time may be calculated if the forces acting on the body are known. The forces acting on a body in an inertial system depend on the body's orientation relative to the air flow, and the body's orientation relative to the inertial system. Thus, in order to reliably calculate the trajectory, it is necessary to evaluate the changes in orientation over time. However, it is challenging to devise a system that simply and reliably determines the orientation of different types of bodies. Different types of bodies under test have different aerodynamic characteristics, which, in turn, cause different effects on the bodies' orientations. For example, an agile air-to-air missile may change its orientation very rapidly, while a space rocket may take a few seconds to change its orientation.

To compensate for these challenges, it would be necessary to conduct a full simulation of the responses of the unit under test to different actuators. Such a simulation is highly computationally intensive, and in particular requires intimate knowledge of the system under test, including the aerodynamic model, thrust profile, actuators dynamics, and detailed evaluation of the response to internal and external forces and moments.

Accordingly, there exists a need to be able to calculate a projected ground impact point of different projectiles, without requiring intensive calculation. There further exists a need to calculate the projected ground impact point of different projectiles regardless of whether they are able to change orientation very quickly or only more gradually.

The present disclosure addresses this need by providing a simplified approach for simulating a path of a projectile, by modeling the orientation and its derivatives (i.e., rates of change of different components of the orientation) as a transfer function. The transfer function may be of any order, and in exemplary embodiments is a second order transfer function with time derivatives.

According to a first aspect, a method of assessing safety of a trajectory of units under test over a flight range is disclosed. The method includes: setting a mission trajectory of a unit under test, wherein nominal and dispersion trajectories of the unit under test are within a delineated area; extracting from the mission trajectory a plurality of initial conditions of the unit under test; for each extracted initial condition, simulating a malfunction, and calculating an orientation of the unit under test following each simulated malfunction using an orientation transfer function of the unit under test to simulate a malfunction maneuver. The method further includes, on the basis of this calculated orientation for each simulated malfunction, determining an impact point of the unit under test with a particular plane.

Advantageously, the transfer function represents a simplified analytical tool for determining orientation, in up to three axes. This, in turn, enables a straightforward, reliable calculation of the impact points with the ground or with any other plane. It is then possible to determine whether a respective calculated impact point is within a delineated area in the flight test range. In the event that the calculated impact point is outside the delineated range, a risk assessment may be conducted.

As another advantage, it is possible to perform this calculation even at an early stage of development of the unit under test, when more specific information is not known, or cannot be calculated or measured precisely. A safety engineer may use this information to design aerodynamic properties of the body, such as center of gravity, in order to meet a desired test safety goal.

Also, the approximation based on the transfer function enables quick evaluation of the sensitivity of the unit under test to changes in parameters. The calculations may be used to evaluate how “fast” forces acting on the body under test are created, since these forces are a function of the orientation in up to three axes.

In another implementation according to the first aspect, the orientation transfer function uses as input the unit under test's orientation, any derivatives of the orientation, or any combination thereof.

In another implementation according to the first aspect, the calculating step includes calculating a first impact point following simulated implementation of a flight termination system by a ground-based computer; calculating a second impact point following simulated implementation of a flight termination system by a human operator; calculating a third impact point following simulated implementation of an automatic flight termination system on board the unit under test; and calculating a fourth impact point following no simulated implementation of a flight termination system.

In another implementation according to the first aspect, wherein the calculating step includes using the orientation transfer function to determine position, velocity and orientation until the unit under test reaches one of the following conditions: a predetermined altitude; a predetermined position; a predetermined point for activation of a flight termination system; or an end of the mission trajectory.

In another implementation according to the first aspect, the orientation transfer function is a first order transfer function for roll of the unit under test, pitch of the unit under test, or yaw of the unit under test.

In another implementation according to the first aspect, the orientation transfer function is a second order transfer function for any two of roll, pitch, and yaw of the unit under test. Optionally, the second order transfer function uses orientation commands of pitch and yaw as initial inputs, and determines values of angle of attack and sideslip angle as outputs.

In another implementation according to the first aspect, the orientation transfer function is a third order transfer function for roll, pitch, and yaw of the unit under test. In another implementation according to the first aspect, the orientation transfer function is of a higher order than a third order transfer function.

In another implementation according to the first aspect, the method further includes applying a first orientation transfer function during a first stage of simulated flight and a second orientation transfer function during a second stage of simulated flight.

In another implementation according to the first aspect, the method further includes adapting the orientation transfer function based on environmental conditions including temperature, air pressure, and wind.

In another implementation according to the first aspect, the method further includes evaluating whether each respective calculated impact point is within a delineated area in the flight test range. Optionally, the method further includes, if a respective calculated impact point is outside the delineated area, adjusting one or more parameters of the mission trajectory, and repeating the setting, extracting, calculating, and determining steps with respect to the adjusted mission trajectory. Optionally, the method further includes, if a respective calculated impact point is outside the delineated area, adjusting one or more aerodynamic properties of the unit under test, and repeating the setting, extracting, calculating, and determining steps with respect to the adjusted unit under test. Optionally, the method further includes, if a respective calculated impact point is outside of the delineated area, performing a risk assessment for an area surrounding the calculated impact point.

According to a second implementation, a computer program product includes a non-transitory computer readable medium storing instructions that, when executed by a computer, causes the computer to perform the following steps: setting a mission trajectory of a unit under test, wherein nominal and dispersion trajectories of the unit under test are within a delineated area; extracting from the mission trajectory a plurality of initial conditions of the unit under test; for each extracted initial condition, simulating a malfunction; calculating an orientation of the unit under test following each simulated malfunction using an orientation transfer function of the unit under test to simulate malfunction maneuver; and on the basis of the calculated orientation for each simulated malfunction, determining an impact point of the unit under test with a particular plane.

### BRIEF DESCRIPTION OF THE DRAWINGS

In the drawings:

FIG. 1 is an orientation command flow chart illustrating how trajectory is determined from a second order transfer function, according to embodiments of the present disclosure;

FIG. 2 is a graphical depiction of an orientation transfer function for two different units under test having different angular frequencies, according to embodiments of the present disclosure;

FIG. 3 is a flow chart illustrating steps of a method for determining the safety of a flight test region, according to embodiments of the present disclosure;

FIG. 4 is a graphical display of projected ground impact points for a unit under test without a flight termination system and having a second order transfer function with an angular frequency of 10 radians per second, according to embodiments of the present disclosure;

FIG. 5 is a graphical display of projected ground impact points for a unit under test without a flight termination system and having a second order transfer function with an angular frequency of 1 radian per second, according to embodiments of the present disclosure;

FIG. 6 is a graphical display of projected ground impact points for a unit under test with a flight termination system and having a second order transfer function with an angular frequency of 10 radians per second, according to embodiments of the present disclosure; and

FIG. 7 is a schematic depiction of components of a computer program for modeling ground impact points of units under test, according to embodiments of the present disclosure.

### DETAILED DESCRIPTION OF THE INVENTION

The present disclosure, in some embodiments, concerns a tool for analyzing flight test range safety, and more specifically, but not exclusively, to a simplified approach for simulating a malfunction maneuver, by using the orientation in three axes and its derivatives as a transfer function of any order, including a second order transfer function with time derivatives. These malfunction trajectories are the basis of flight test mission planning under test range and regulatory constraints including the requirement of a comprehensive risk assessment.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As used in the present disclosure, the term “orientation” refers to the angular position, or attitude, of the unit under test, within the space that it occupies. Orientation may be expressed numerically as the angles made by the body under test with respect to each of the x, y, and z axes. The term “body rate” refers to the combined change in angular velocity of the body under test, in all measured angles. The term “angle of attack,” designated by the Greek letter alpha (a), refers to the angle between the x,y plane and the longitudinal axis of the body under test, and is used in determining a magnitude of a force of lift and drag. The term “sideslip angle,” designated by the Greek letter beta (B), refers to the angle between the velocity vector of the body under test and the projection of the longitudinal axis of the unit under test onto the x,y plane, and thus describes whether there is a lateral component to the velocity of the unit under test relative to the air flow.

The present disclosure utilizes a closed loop controller to simulate behavior of orientation commands over time. The closed-loop controller applies a transfer function to describe the behavior of the orientation over time, in up to three axes. The transfer function may be of any order. For a first order transfer function, the user defines the properties of the first order behavior, namely the time constant (t). The first order transfer function may be used to describe the behavior of roll of the unit under test, pitch of the unit under test, or yaw of the unit under test. For a second order transfer function, the user defines the properties of the second order behavior, namely frequency (ω) and damping (ζ). The second order transfer function may be used to describe the behavior of any two of roll, pitch, and yaw of the unit under test. A third order transfer function may simulate the behavior of all three of roll, pitch, and yaw. A higher order transfer function may also be used.

The output of this controller is the body rate of the unit under test. Integration of the body rate in time yields the body orientation, in up to three axes.

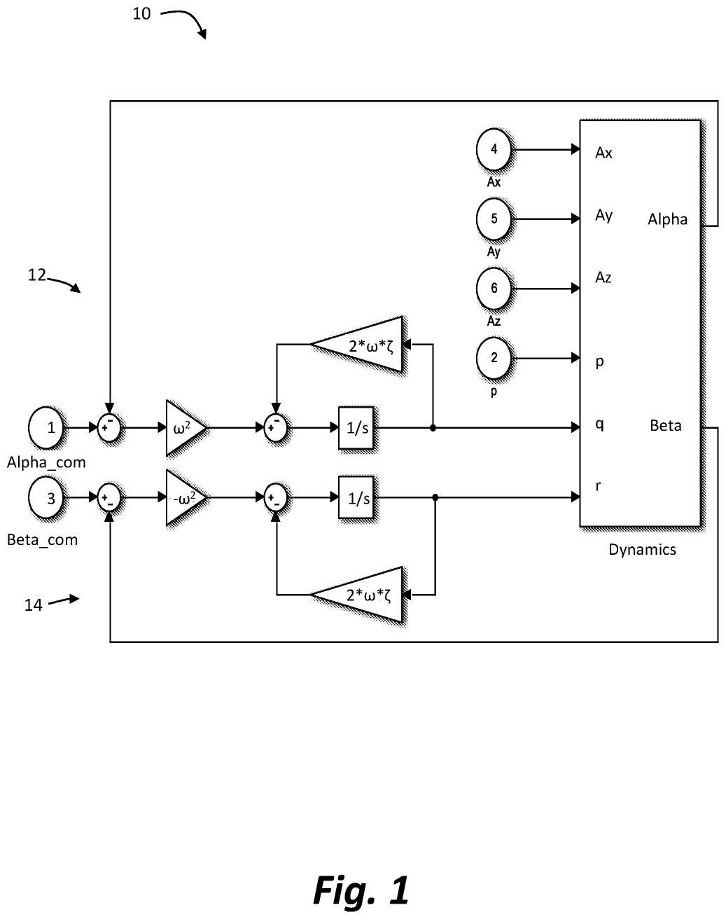

FIG. 1 depicts dynamic block diagram 10, which illustrates graphically how this transfer function is used to determine body rate. Dynamic block 10 includes six degree of freedom equations as inputs-three for orientation (labeled 1, 2, and 3) and three for position (labeled 4, 5, and 6). The three position equations use acceleration commands Aₓ, A_{y}, and A_{z}, which represent the acceleration of the object in the x, y, and z directions, respectively. The acceleration commands are calculated using standard methods, such as simplified aerodynamic, mass, and thrust models. The three orientation equations 1, 2, 3 are respectively for calculating roll (p), pitch (q), and yaw (r). Roll refers to rotation around the x axis, pitch refers to rotation around the y axis, and yaw refers to rotation around the z axis.

In the example of a second-order transfer function, dynamic block 10 provides an approximation of two orientation commands. The second order transfer function expresses these two commands as dependent on two variables—omega (ω), which represents the angular frequency (i.e., how fast the angular orientation changes), and zeta (ζ), which represents the damping of the system. Different units under test necessarily have different values for these variables. For example, a more agile unit under test, like an air-to-air missile, has a larger angular frequency, while a less agile unit under test, such as a heavy space rocket, has a smaller angular frequency. The parameters of a transfer function applicable to a particular unit under test may be derived from the basic lateral dynamics of that unit under test.

The transfer function may also have constants that are adapted to particular environmental conditions of the test range. These environmental conditions may include, for example, temperature, air pressure, and wind.

Because the transfer function used is merely an approximation of the orientation commands over time, it may be intentionally defined in a manner that is stricter than the actual performance of the unit under test (i.e., a manner that produces a greater margin of error). For example, the transfer function may correspond to the worst-case scenario, or even a value that is stricter than the worst-case scenario, in order to err on the side of safety. Similarly, the transfer function may be used in order to evaluate software for operating the unit under test, and to form a security buffer with respect to the boundaries of the flight range, even in situations when the malfunction maneuvering of the unit under test are known.

For purposes of calculation the transfer function can be used on one or more initial values per axis. For example, for the second order transfer function described herein, the two inputs for pitch (q) and yaw (r) are used as initial values. In alternative embodiments, roll (p) is also used in calculation of the transfer function. One reason for choosing pitch and yaw for initial values is that many units under test are designed to have stability in the roll plane, such that changes in the roll component of orientation are less significant. It is also possible to apply a first transfer function during a first stage of simulated flight and a second transfer function during a second stage of simulated flight. For example, different inputs may be used for the transfer function, or different order transfer functions may be used, at different stages of the calculation.

As shown in the example of FIG. 1, the initial inputs of the second order transfer function are the two orientation commands (1) and (3). The outputs of the second order transfer function are α and β, the angle of attack and sideslip angle commands, respectively. In block 12, the derivative of the α command is obtained, and in block 14, the derivative of the β command is obtained. These outputs are fed back into the dynamic block for further processing in order to determine orientation.

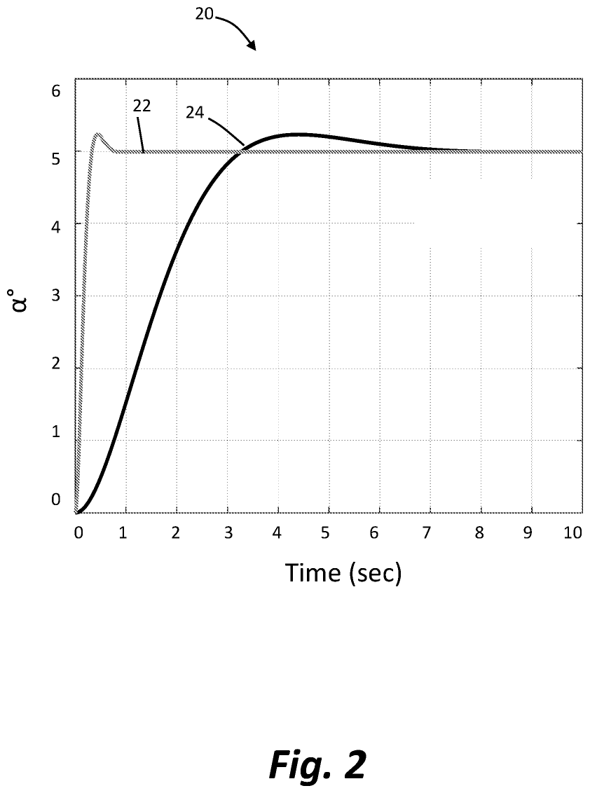

FIG. 2 illustrates the output of the exemplary second order transfer function for angle of attack, for two different units under test, according to embodiments of the present disclosure. The output is illustrated on graph 20 as a function of time. The y-axis α represents change in angle of attack α of the body under test. Curve 22 represents the orientation of an agile air-to-air missile, which has an angular frequency ω of 10 radians/second, and curve 24 represents the orientation of a more cumbersome space rocket, which has an angular frequency ω of 1 radian/second. In both cases, the damping value ζ is 0.7, and thus the orientation transfer function is underdamped. As can be seen, the missile reaches its angle of attack after approximately 1 second, while the rocket is slower to change its angle of attack, and reaches its angle of attack after only approximately eight seconds.

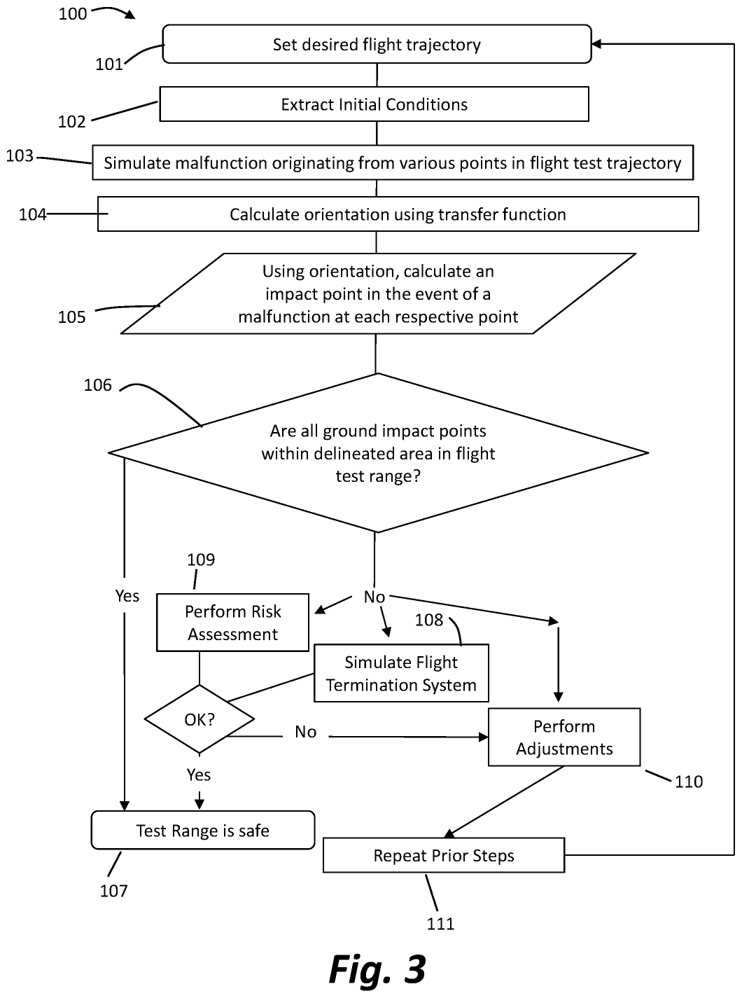

FIG. 3 is a flow chart illustrating steps of a method 100 for determining the safety of a flight test region, according to embodiments of the present disclosure. Reference will also be made during the exposition of FIG. 3 to FIGS. 4-6, which schematically depict the ground impact point of units under test under various test conditions, according to embodiments of the present disclosure.

Referring to FIG. 3, at step 101, the user (for example, a director of a flight test range, or someone acting under his or her authority) sets at least one simulated flight test trajectory. In the design that is set, both nominal and dispersion trajectories of the unit under test are within a delineated area. The unit under test is thus expected to fall within the delineated area of the flight test range.

At step 102, during the flight test of step 101, the user, operating a computer program product, extracts from the mission trajectory a set of initial conditions of the unit under test. These initial conditions include parameters such as position, velocity, and acceleration in three axes.

At step 103, the computer program simulates a malfunction originating at each of the initial conditions extracted during step 102.

At step 104, the computer program calculates an orientation of the unit under test following each simulated malfunction, using an initial orientation of the unit under test and an orientation transfer function. For example, this calculation is performed by calculating the first, second, or higher order transfer function of one or more components of the orientation, in the manner described above in connection with FIG. 1. The transfer function may use as inputs components of the orientation of the unit under test, any derivatives of such components, and/or any combination of said components. The transfer function may be used until the trajectory reaches a desired condition (for example, altitude, position, or pre-programmed activation of a flight termination system) or until the end of the trajectory through impact with the ground.

At step 105, the computer program calculates an impact point in the event of a malfunction at each respective time point, based on the orientation that is modeled with the transfer function. The impact point may be an impact point with the ground, or with any other plane of interest, such as an elevation at which passenger aircraft routinely fly. This calculation effectively simulates the results of a malfunction at each of the selected points. Notably, the physical behavior of the unit under test is represented by the transfer function only, without requiring recourse to more complex calculations. In addition, because the calculation of the orientation with the transfer function is relatively quick, it is possible to perform a nearly infinite number of simulations, in order to reduce the possibility of statistical errors.

At step 106, all of the calculated impact points are plotted against the delineated area of the flight test range. The plot is then evaluated to determine whether each respective calculated impact point is within the delineated area.

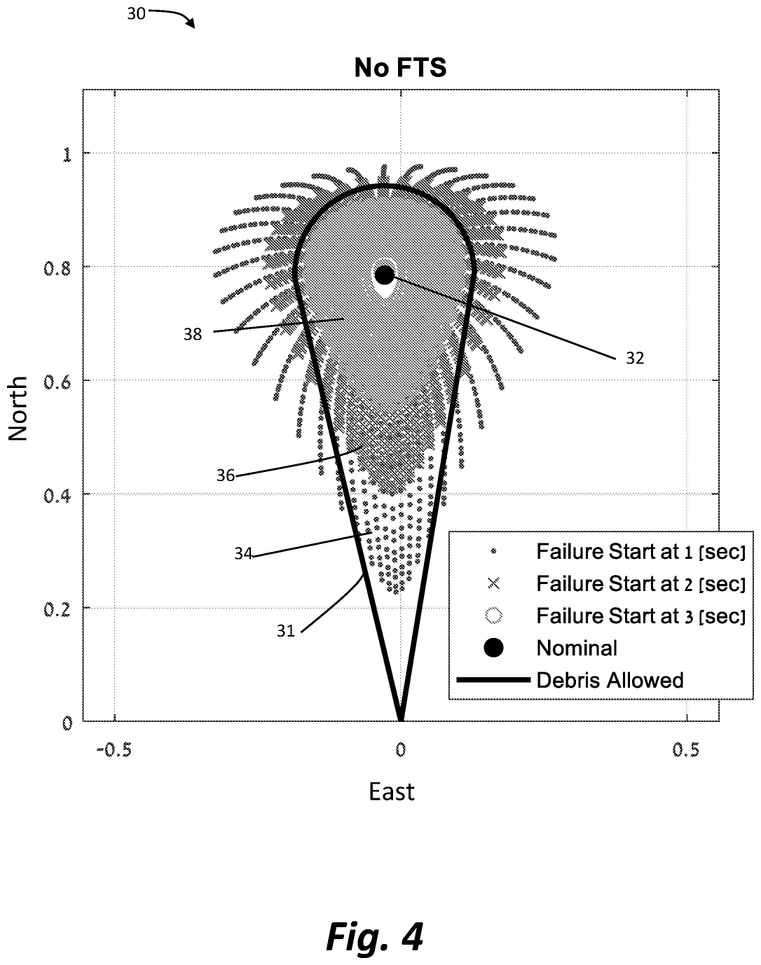

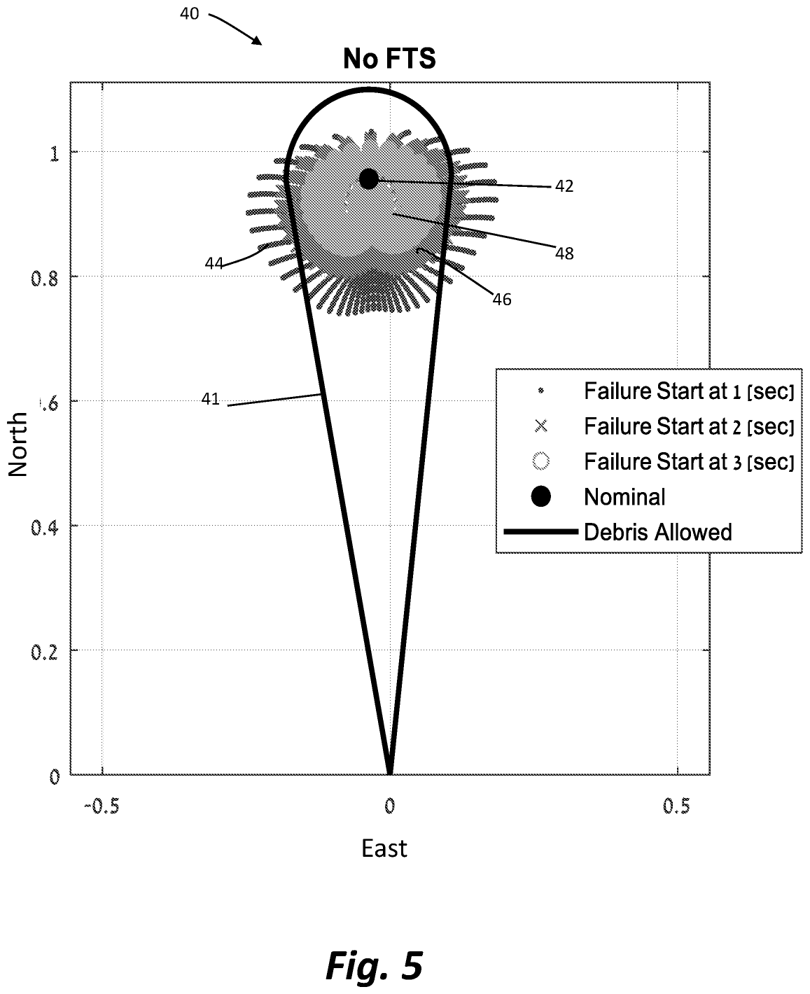

Examples of plots generated in step 106 are shown in FIGS. 4 and 5. FIG. 4 models the behavior of an agile air-to-air missile with an angular velocity ω of 10 radians/second. Referring to FIG. 4, plot 30 includes delineated area 31, and nominal target point 32. The nominal target point 32 is the point at which the unit under test is expected to hit, barring a malfunction. The impact points are calculated at three times, representing three malfunction times: one second, two second, and three seconds. The plot 30 includes, as scatter points, each of the calculated impact points. Dot-shaped scatter points 34 are the impact points calculated at one second; x-shaped scatter points 36 are the impact points calculated at two seconds; and circle-shaped scatter points 38 are the impact points calculated at three seconds. As can be seen, at all three times, some of the impact points are outside the delineated area 31.

FIG. 5 models the behavior of a cumbersome heavy space rocket with an angular velocity ω of 1 radian/second. Plot 40 includes delineated area 41 and nominal landing point 42. As in FIG. 4, the dot-shaped scatter points 44 are the impact points calculated at one second, the x-shaped scatter points 46 are the impact points calculated at two seconds, and the circle-shaped scatter points 48 are the impact points calculated at three seconds. As can be seen, even for the rocket, a significant portion of the impact points are outside the delineated area 41.

The next steps of the method depend on the outcome of the calculation of ground impact points performed in step 106. If all impact points are within the delineated area, then the test range is determined to be safe, as shown at step 107. If, however, some of the ground impact points are outside the delineated area (as is the case in FIGS. 4 and 5), it is necessary to perform further analysis.

For example, at step 108, the simulation considers the implementation of a flight termination system. There are three scenarios regarding implementation of a flight termination system: the flight termination system may be implemented by a human operator, such as a security officer; by a ground-based computer; or by an automatic flight termination system on board the unit under test. For the computer-based systems, the flight termination system may be programmed to be activated whenever the body under test crosses a virtual line in space. Alternatively, the flight termination system may not be implemented at all. Depending on the implementation, more or less lead time is required for initiating the flight termination system. A human operator requires more lead time for implementation of a flight termination system than a ground-based computer, and the ground-based computer requires more time than an on-board computer. As a result, each of the flight termination systems may result in a different pattern of risk in the event of a malfunction.

The system calculates the impact points based on each of these scenarios for the flight termination system, and determines the likelihood of the malfunction resulting in the unit under test landing outside the delineated area, after considering the implementation of the flight termination system.

Relatedly, outside of the context of a malfunction, the transfer function is used to prepare boundaries of the implementation of the flight termination system under each of these scenarios. A “secure zone” may be defined with different boundaries for implementation of the flight termination system, depending on whether the implementation is performed by a security officer, a field-based computer, or an on-board computer.

In addition or in the alternative, at step 109, the system performs a risk assessment. This risk assessment assesses the risk that the unit under test will fall in particular areas outside the test range. This risk assessment is required for regulatory compliance.

If the result of the analyses of the flight termination system and/or risk assessment are that the test range remains within acceptable boundaries for risk, then the test range is considered safe, as shown at step 106. Otherwise, it is necessary to perform adjustments, as shown in step 110. In general, there are three types of relevant adjustments.

One option is to change the trajectory of the unit under test. The changing of the trajectory may be achieved, for example, by changing a launch angle or speed of the unit. A second option is to implement a flight termination system, or a different type of flight termination system than one which had previously been implemented, for example an autonomous on-board flight termination system versus a ground-based flight termination system. In addition or alternatively, the physical properties of the unit may be modified. For example, the center of gravity or other aerodynamic properties of the unit may be updated, so that the forces acting on the unit move the unit only within the delineated area.

Following performance of the adjustments of step 110, the prior steps are repeated, as indicated in block 111. That is, once again, a flight trajectory is set including all dispersions, initial conditions are extracted, malfunctions are simulated, the orientation is calculated using the transfer function, and the impact points are calculated in the event of a malfunction at each respective point. The impact points are then compared to the delineated area in the flight test range, and the safety of the test range is evaluated.

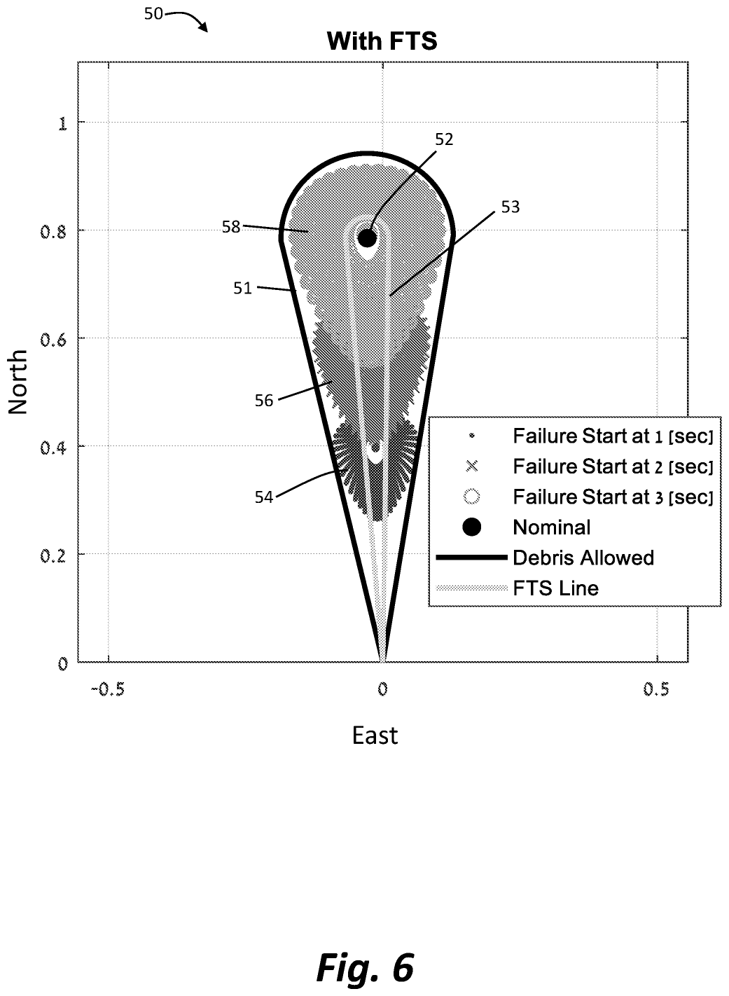

An exemplary demonstration of the effect of a flight termination system on the impact points is illustrated in FIG. 6. Plot 50 includes delineated area 51 and nominal landing point 52. Similar to FIGS. 3 and 4, the dot-shaped scatter points 54 are the impact point calculated at one second, the x-shaped scatter points 56 are the impact points calculated at two seconds, and the circle-shaped scatter points 58 are the impact points calculated at three seconds. However, unlike the models depicted in FIGS. 3 and 4, the projectiles modeled in FIG. 6 are equipped with a flight termination system. The flight termination system is programmed to engage whenever the projectiles cross line 53. As a result, each of the impact points remains within the delineated area 51. The method then proceeds to step 106, in which the test range is determined to be safe.

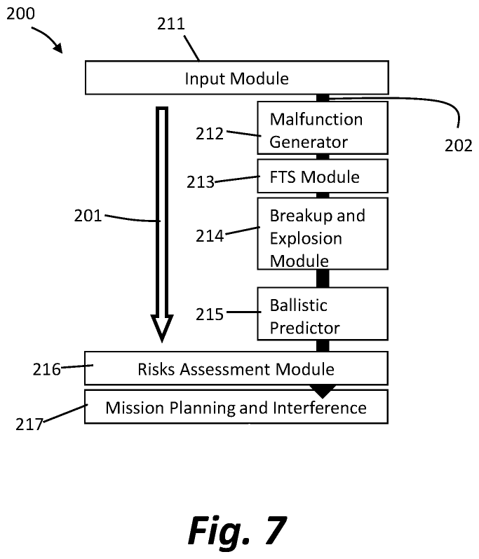

FIG. 7 illustrates schematically certain components of a computer program product 200 for test range safety analysis that is used to implement the above-described method. The computer program product incorporates numerous capabilities in a single framework. These capabilities include risk analysis, safety and operations concept planning, and mission plan optimization. The capabilities may further include deployment planning and optimization for sensors, taking into account nominal and malfunction trajectories. The system is modular and can be operated with all, or some, of the depicted modules.

Arrow 201 depicts use of the program 200 in a nominal manner (i.e., without a malfunction), skipping certain of the modules described here, while arrow 202 depicts uses of the program 200 in event of a simulated malfunction. The program begins with an input module 211 which provides initial input for launch trajectory of a projectile. A malfunction generator 212 generates initial physical conditions that are propagated to malfunction trajectories during a simulated malfunction, using the transfer function. Flight Termination System 213 simulates a breakup of the projectile, which would be performed in real life by a safety officer or an Autonomous Flight Termination System (AFTS). Breakup and explosion module 214 sets the initial dynamics and properties of all objects, including fragments. Ballistic predictor 215 is used to propagate these trajectories along an altitude of interest (i.e., ground or sea impact points, or typical aviation cruising altitudes), taking into account atmosphere and wind. A risk assessment module 216 performs a comprehensive risk assessment on the basis of all the data generated by the previous modules. Finally, mission planning and interference mapping module 217 uses information taken from the risk assessment module to prepare a master plan for the flight test, thereby completing the test range planning.

What is claimed is:

1. A method of assessing safety of a trajectory of a unit under test over a flight test range, comprising:
setting a mission trajectory of a unit under test, wherein nominal and dispersion trajectories of the unit under test are within a delineated area;
extracting from the mission trajectory a plurality of initial conditions of the unit under test;
for each extracted initial condition, simulating a malfunction;
calculating an orientation of the unit under test following each simulated malfunction using an orientation transfer function of the unit under test to simulate a malfunction maneuver; and
on the basis of the calculated orientation for each simulated malfunction, determining an impact point of the unit under test with a particular plane.

2. The method of claim 1 wherein said orientation transfer function uses as input the unit under test's orientation, any derivatives of the orientation, or any combination thereof.

3. The method of claim 1, wherein the calculating step comprises calculating a first impact point following simulated implementation of a flight termination system by a ground-based computer; calculating a second impact point following simulated implementation of a flight termination system by a human operator; calculating a third impact point following simulated implementation of an automatic flight termination system on board the unit under test; and calculating a fourth impact point following no simulated implementation of a flight termination system.

4. The method of claim 1, wherein the calculating step comprises using the orientation transfer function to determine position, velocity and orientation until the unit under test reaches one of the following conditions: a predetermined altitude; a predetermined position; a predetermined point for activation of a flight termination system; or an end of the mission trajectory.

5. The method of claim 1, wherein the orientation transfer function is a first order transfer function for roll of the unit under test, pitch of the unit under test, or yaw of the unit under test.

6. The method of claim 1, wherein the orientation transfer function is a second order transfer function for any two of roll, pitch, and yaw of the unit under test.

7. The method of claim 6, wherein the second order transfer function uses orientation commands of pitch and yaw as initial inputs, and determines values of angle of attack and sideslip angle as outputs.

8. The method of claim 1, wherein the orientation transfer function is a third order transfer function for roll, pitch, and yaw of the unit under test.

9. The method of claim 1, wherein the orientation transfer function is of a higher order than a third order transfer function.

10. The method of claim 1, further comprising applying a first orientation transfer function during a first stage of simulated flight and a second orientation transfer function during a second stage of simulated flight.

11. The method of claim 1, further comprising adapting the orientation transfer function based on environmental conditions including temperature, air pressure, and wind.

12. The method of claim 1, further comprising evaluating whether each respective calculated impact point is within a delineated area in the flight test range.

13. The method of claim 12, further comprising, if a respective calculated impact point is outside the delineated area, adjusting one or more parameters of the mission trajectory, and repeating the setting, extracting, calculating, and determining steps with respect to the adjusted mission trajectory.

14. The method of claim 12, further comprising, if a respective calculated impact point is outside the delineated area, adjusting one or more aerodynamic properties of the unit under test, and repeating the setting, extracting, calculating, and determining steps with respect to the adjusted unit under test.

15. The method of claim 12, further comprising, if a respective calculated impact point is outside of the delineated area, performing a risk assessment for an area surrounding the calculated impact point.

16. A computer program product comprising a non-transitory computer readable medium storing instructions that, when executed by a computer, causes the computer to perform the following steps:
setting a mission trajectory of a unit under test, wherein nominal and dispersion trajectories of the unit under test are within a delineated area;
extracting from the mission trajectory a plurality of initial conditions of the unit under test;
for each extracted initial condition, simulating a malfunction;
calculating an orientation of the unit under test following each simulated malfunction using an orientation transfer function of the unit under test to simulate malfunction maneuver; and
on the basis of the calculated orientation for each simulated malfunction, determining an impact point of the unit under test with a particular plane.
